(19) United States
(12) Patent Application Publication
(10) Pub. No.: US 2009/0202079 A1
(43) Pub. Date: Aug. 13, 2009

(54) Method, apparatus and computer program product for providing mobile broadcast service protection

(75) Inventors: Matti Puputti, Turku (FI); Jukka Alve, Vantaa (FI); Timo Karras, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/029,205

(22) Filed: Feb. 11, 2008

(51) Int. Cl. H04L 9/08

(52) U.S. Cl. 380/279

(57) ABSTRACT

An apparatus for providing mobile broadcast service protection may include a processor. The processor may be configured to receive an indication of device groupings defining at least a first group of devices and a second group of devices in which the first and second groups are defined on the basis of a device characteristic, communicate a first security key providing access to a first message stream associated with a mobile broadcast service to the first group of devices, and communicate a second security key providing access to a second message stream associated with the same mobile broadcast service to the second group of devices. Methods and computer program products corresponding to the apparatus are also provided from the perspective of a network device and mobile terminal.

### TECHNOLOGICAL FIELD

Embodiments of the present invention relate generally to Digital Rights Management (DRM) and, more particularly, relate to a method, apparatus and computer program product for providing service protection, for example, in a mobile broadcast service environment.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or request made by the user (e.g., content searching, content streaming, etc.). The services may be provided from a network server or other network device, or even from the mobile terminal such as, for example, a mobile telephone, a mobile television, a mobile gaming system, etc.

There has been a recent demand for services related to mobile broadcasts. In response to such demand, the Open Mobile Alliance (OMA), a standards body that develops open standards for the mobile communications industry, has developed OMA BCAST, as a standard for Mobile Broadcast Services. One area of concern for OMA BCAST is related to broadcast service and content protection issues. In order to protect system and content security, some form of security protection is typically employed. For example, DRM using a DRM Profile may be employed. More recently, a Smartcard Profile solution has been implemented under which responsibility for security may be shifted to a smartcard provider. SimulCrypt is a security standard currently employed in pay-TV systems, which allows multiple different conditional access systems to be used for protected key distribution, even though the content of the pay-TV service is encrypted and transmitted only once. Typically these conditional access systems utilize security keys, some of which never leave a conditional access module or smartcard in order to provide enhanced security. Using this standard, it may even be possible to shut down one conditional access system in response to a compromise of security. A switch over to a new conditional access system may then be accomplished by issuing new smartcards.

Despite the existence of specific solutions that may be applicable in certain applications, it may be desirable to provide a fully standardized service protection system, for example, in which the security lies in the terminal implementation. Such a fully standardized service protection system would have the advantage that it would allow a traveler to access local mobile television broadcasts with his or her mobile terminal anywhere in the world, without worries over whether the terminal and/or Smartcard happens to support a particular conditional access system selected by a local broadcaster. However, especially in an environment where many terminal manufacturers may produce competing products, it may be difficult to ensure that no manufacturers cut corners with regard to security (e.g., for cost cutting advantages). For example, if the security of a terminal product manufactured by a particular company is compromised due to a weakness in the company's security, a hacker may be able to extract the Service Encryption Key (SEK) that protects access to encrypted services from the terminal product. The hacker could then, for example, publish the SEK on a non-traceable web page, and distribute an application that can be used to decrypt encrypted services using the compromised key fetched from the web page. Under these circumstances, it is typically difficult for the broadcaster to determine which product has experienced a security breach. Accordingly, identifying, correcting, or taking action against a manufacturer with poor security may be difficult. Furthermore, issuing a patch to cure the security weakness may similarly be difficult to accomplish.

While adoption of a Smartcard Profile may be one approach to dealing with the scenario above, it may be desirable to develop an approach to mitigating the problems described above using a DRM Profile related solution.

### BRIEF SUMMARY

A method, apparatus and computer program product are therefore provided to enable mobile broadcast service protection. In particular, a method, apparatus and computer program product are provided that may enable a broadcaster to identify a product manufacturer that has produced a product that is the source of a security leak. For example, different keys may be issued to at least two groups of devices on the basis of device manufacturer. Accordingly, if a security leak is detected, groupings may be changed with respect to newly issued keys. By strategically changing the groupings such as by sequentially splitting each group associated with the security leak (e.g., including devices from the manufacturer having the security breach) for subsequently issued keys, the group corresponding to the security leak may eventually include only a single manufacturer that has corresponded to the group with the security leak for each iteration and the identity of the manufacturer with the security leak may be determined.

In one exemplary embodiment, a method of providing mobile broadcast service protection is provided. The method may include receiving an indication of device groupings defining at least a first group of devices and a second group of devices in which the first and second groups are defined on the basis of a device characteristic, communicating a first security key providing access to a first message stream associated with a mobile broadcast service to the first group of devices, and communicating a second security key providing access to a second message stream associated with the same mobile broadcast service to the second group of devices in which the first and second security keys are different.

In another exemplary embodiment, a computer program product for providing mobile broadcast service protection is provided. The computer program product includes at least one computer-readable storage medium having computer-readable program code portions stored therein. The computer-readable program code portions include first, second and third executable portions. The first executable portion is for receiving an indication of device groupings defining at least a first group of devices and a second group of devices in which the first and second groups are defined on the basis of a device characteristic. The second executable portion is for communicating a first security key providing access to a first message stream associated with a mobile broadcast service to the first group of devices. The third executable portion is for communicating a second security key providing access to a second message stream associated with the same mobile broadcast service to the second group of devices in which the first and second security keys are different.

In another exemplary embodiment, an apparatus for providing mobile broadcast service protection is provided. The apparatus may include a processor. The processor may be configured to receive an indication of device groupings defining at least a first group of devices and a second group of devices in which the first and second groups are defined on the basis of a device characteristic, communicate a first security key providing access to a first message stream associated with a mobile broadcast service to the first group of devices, and communicate a second security key providing access to a second message stream associated with the same mobile broadcast service to the second group of devices.

Embodiments of the invention may provide a method, apparatus and computer program product for employment in mobile broadcast environments in which service protection is provided. As a result, for example, broadcasters may be enabled to isolate security breaches to a particular device manufacturer. As such, for example, broadcasters may employ a forensic method for providing mobile broadcast service protection.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a communication system according to an exemplary embodiment of the present invention;

FIG. 3 illustrates a block diagram of an apparatus for providing mobile broadcast service protection according to an exemplary embodiment of the present invention;

FIG. 4 illustrates a key hierarchy according to an exemplary embodiment of the present invention;

FIG. 5 is a flowchart according to an exemplary method for providing mobile broadcast service protection according to an exemplary embodiment of the present invention; and

FIG. 6 is a flowchart according to an exemplary method for providing mobile broadcast service protection from the perspective of a mobile terminal according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

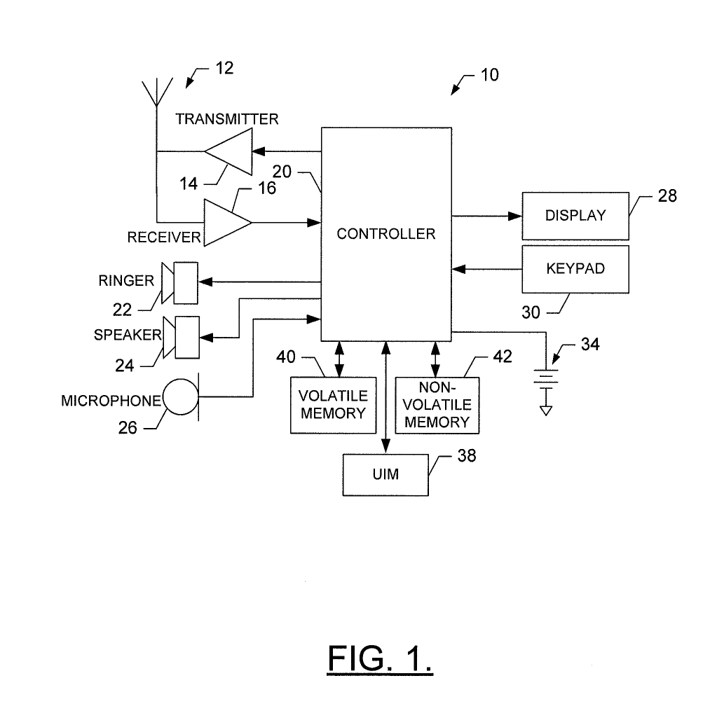

FIG. 1, one aspect of the invention, illustrates a block diagram of a mobile terminal 10 that may benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

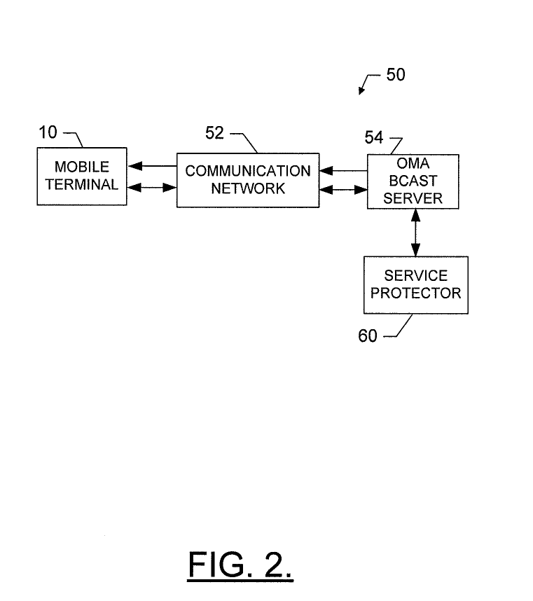

The mobile terminal 10 may include an antenna 12 (or multiple antennae) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

FIG. 2 is a schematic block diagram of a communications system 50 according to an exemplary embodiment of the present invention. Referring now to FIG. 2, an illustration of one type of system that would benefit from embodiments of the present invention is provided. The system 50 may include a communication network 52 having potentially a plurality of network devices, an OMA BCAST server 54 and one or more mobile terminals 10. The mobile terminal 10 may be in communication with the OMA BCAST server 54 via the communication network 52. In general, the communication network 52 may be a network operating any of a plurality of known communication protocols. In this regard, the communication network 52 may be capable of supporting communication in accordance with any one or more of a number of first-generation (1G), second-generation (2G), 2.5G, third-generation (3G), 3.9G, fourth-generation (4G) mobile communication protocols or the like. For example, one or more of the communication network 52 may be capable of supporting communication in accordance with 2G wireless communication protocols IS-136 (TDMA), GSM, and IS-95 (CDMA). Also, for example, the communication network 52 may be capable of supporting communication in accordance with 2.5G wireless communication protocols GPRS, Enhanced Data GSM Environment (EDGE), or the like. Further, for example, the communication network 52 may be capable of supporting communication in accordance with 3G wireless communication protocols such as a UMTS network employing WCDMA radio access technology. Furthermore, the communication network 52 may utilize DVB-H broadcast technology for the downstream direction from the OMA BCAST server 54 to the mobile terminal 10.

In an exemplary embodiment, the communication network 52 may include an IP based broadcast delivery network (e.g. 3GPP2 (Third Generation Partnership Project 2) or IP datacasting (IPDC) over DVB-H) for delivering, for example, video broadcast services to the mobile terminal 10 (e.g., via a broadcast channel). The communication network 52 may also include an interaction or interactive channel (e.g. provided by a cellular network) for providing interaction between the mobile terminal 10 and service provisioning functions of the OMA BCAST server 54. The service provisioning functions of the OMA BCAST server 54 may include, for example, service or content purchase and payment functions.

The OMA BCAST server 54 may provide functionality to authenticate requests to view OMA BCAST content or services via an OMA BCAST service guide (e.g., an electronic service guide (ESG)). The OMA BCAST server 54 may then provide the OMA BCAST content or services, for example, following authentication of the request or payment for such content or services. Selection of the OMA BCAST service guide may enable a user to initiate a subscription to an OMA BCAST service guide “program”. In response to a user selecting the OMA BCAST service guide, the OMA BCAST server 54 may provide information regarding available programs or services that are available in a service announcement, which may include program details. In some instances, the service announcement for a particular program may include an SDP (session description protocol) file corresponding to the program and providing information on an IP address at which the program may be accessed.

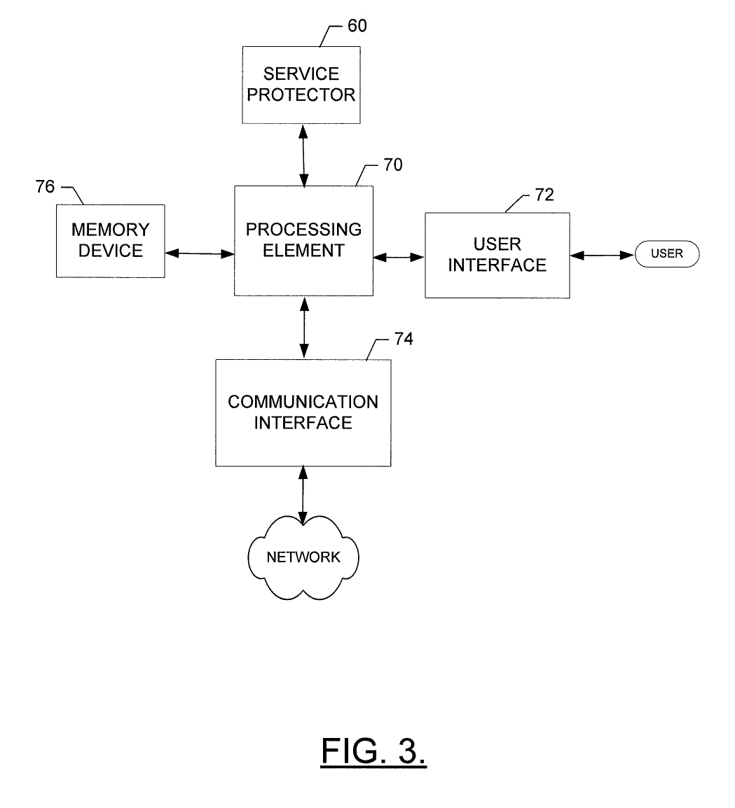

In situations in which a security leak is detected, such as when a hacker is known to be publishing security keys as described above, it may be desirable to implement measures to determine which device manufacturer is the source of the security leak. Accordingly, embodiments of the present invention may address this desire by adding functionality for service protection that may enable the identification of the source of the security leak by providing a service protector 60 as described below and illustrated in one exemplary form in FIG. 3. The service protector 60 may be any means such as a device or circuitry embodied in hardware, software, or a combination of hardware and software that is configured to perform the corresponding functions of the service protector 60 as described in greater detail below. In this regard, for example, the service protector 60 may be configured to issue separate security keys for groups of device manufacturers, which keys may thereafter be changed along with strategic grouping changes that may enable the security leak to be identified. The service protector 60 may be collocated with, part of, or in communication with the OMA BCAST server 54.

In an exemplary embodiment, content or data may be communicated over the system 50 of FIG. 2 between a mobile terminal, which may be similar to the mobile terminal 10 of FIG. 1, and the OMA BCAST server 54 of the system 50 of FIG. 2 in order to, for example, provide broadcast services to the mobile terminal 10 and/or other mobile terminals. However, it should be understood that the system 50 of FIG. 2 and the mobile terminal 10 are merely provided for purposes of example and not by way of limitation.

In this regard, for example, although FIG. 2 illustrates an embodiment in which the mobile terminal 10 is in communication with the OMA BCAST server 54 via the communication network 52, which may be assumed to have an interactive channel, other communication mechanisms are also possible. For example, in some embodiments, devices in communication with the OMA BCAST server 54 may be considered either “connected devices” or “non-connected devices”. In this regard, a connected device may be a device that is connected to the server via the communication network 52 having an interactive channel. Accordingly, while the connected device is in communication with the OMA BCAST server 54, the OMA BCAST server 54 may always be aware of information that may be indicative of the connected device's manufacturer (e.g., the device certificate or DRM agent certificate). The device certificate may include a public key issued to the device and a manufacturer identification. However, a non-connected device may be a device in communication with the OMA BCAST server 54 via a mechanism that lacks or otherwise does not employ an interactive channel. Thus, the OMA BCAST server 54 may not be made aware of information indicative of the manufacturer of the non-connected device since no device certificate may be apparent to the OMA BCAST server 54.

Accordingly, for example, another mechanism such as a database storing manufacturer information for each device (or at least for non-connected devices) may be utilized to provide manufacturer information for non-connected devices. In this regard, the database (e.g., the memory device 76 of FIG. 3) may store the certificate, or information derived therefrom, for each device. In an exemplary embodiment, during registration, a rights issuer may look up the certificate for a device by the unique device number (UDN) of the device, which may be provided by a user of the device. The user may provide the UDN or similar information by numerous mechanisms. For example, the user may provide such information by voice communication, via a web based or other electronically submitted entry form, via mail, etc. As such, an operator may, for non-connected devices, request the user to specify information that may be used to determine the manufacturer of the device and a database may be built on the basis of the information provided so that, regardless of whether any particular device is connected or non-connected, groupings may be made on the basis of manufacturer for the purposes of employing embodiments of the present invention as described in greater detail below. As an alternative, the information indicative of the manufacturer of the device may be included in the UDN.

In general, although grouping of devices may be accomplished in other ways, the device certificate or information that may be derived therefrom typically provides an indication of the manufacturer of the device. The device certificate may also include other information that may be indicative of device type or other characteristics, which could be used as the basis for group forming and security leak isolation using the mechanisms described below. As such, although an embodiment will be described in greater detail below in the context of groupings based on manufacturer, it should be appreciated that such grouping could alternatively be made on the basis of another device characteristic.

An exemplary embodiment of the invention will now be described with reference to FIG. 3, in which certain elements of an apparatus (e.g., the OMA BCAST server 54) for enabling the provision of service protection in accordance with embodiments of the present invention are displayed. The apparatus of FIG. 3 may be embodied as or otherwise employed, for example, on a network device such as the OMA BCAST server 54 of FIG. 2. However, it should be noted that the apparatus of FIG. 3, may also be employed on a variety of other devices, and therefore, embodiments of the present invention should not be limited to application on devices such as servers. It should also be noted that while FIG. 3 illustrates one example of a configuration of an apparatus for enabling the provision of service protection in accordance with embodiments of the present invention, numerous other configurations may also be used to implement embodiments of the present invention.

Referring now to FIG. 3, an apparatus for enabling the provision of service protection is provided. The apparatus may include or otherwise be in communication with a processing element 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information in the form of static and/or dynamic information.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network (e.g., the communication network 52).

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or even eliminated. However, in some instances, the user interface 72 may enable a user (e.g., a network operator or employee of a broadcaster) to provide input defining which manufacturers to associate with a particular group and/or providing information as to which current or previously used security key is characterized as compromised (e.g., the subject of a security leak).

In an exemplary embodiment, the processing element 70 may be embodied as or otherwise control the service protector 60. However, as indicated above, the service protector 60 could be physically disposed remotely with respect to the processing element 70. The service protector 60 may be, in an exemplary embodiment, an application including instructions for execution of various functions in association with embodiments of the present invention. In an exemplary embodiment, the service protector 60 may include or otherwise communicate with applications, algorithms and/or circuitry for providing service protection functions as described herein. The service protection functions may be fully or partially automated. In other words, in some embodiments, the service protector 60 may be configured to automatically gather or receive information and operate in a predefined manner in response to and/or based on the information. Alternatively, a broadcaster may provide inputs to the service protector 60 defining groupings of manufacturers and the service protector 60 may operate to issue security keys based on the defined groupings and/or other information.

The definition of groupings of manufacturers and issuance of keys may be performed in a manner such that each grouping receives a particular different security key (e.g., a Service Encryption Key (SEK)). Grouping changes and key changes may thereafter be accomplished either entirely by the service protector 60 or by the service protector 60 based on user input from the broadcaster. In some instances, the service protector 60 may only operate in response to a suspected security leak. However, it may be advantageous to utilize the service protector 60 on a continuous basis in some situations. For example, it may be desirable to ensure that a hacker is unaware that a security leak is known to have occurred. As such, if the service protector 60 only operated when a security leak was suspected, the hacker may determine that a security leak is suspected and the hacker may temporarily suspend operations to avoid detection. Therefore, continuous operation of the service protector 60 may prevent the hacker from being informed that the security leak has been detected.

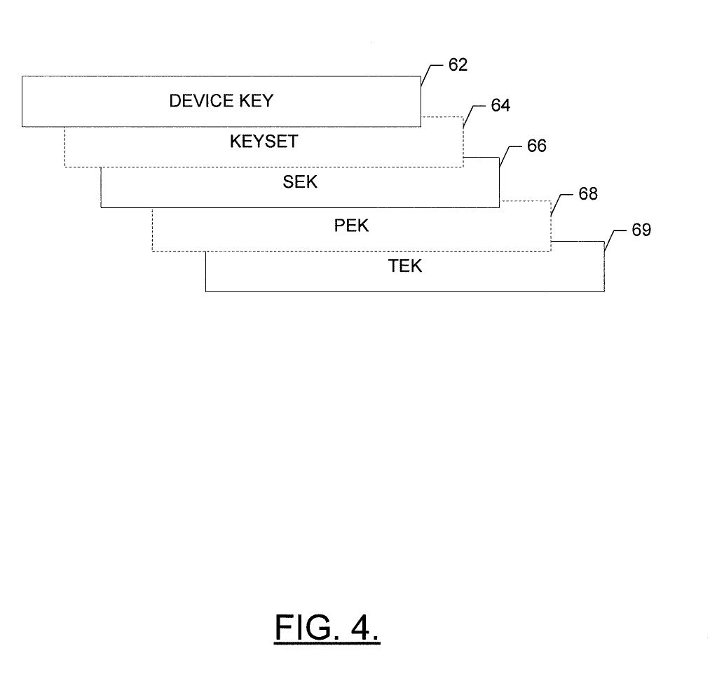

FIG. 4 illustrates a key hierarchy in accordance with embodiments of the present invention. In this regard, the operation of the service protector 60 in relation to security key changes may be better understood in the context of understanding the key hierarchy provided below. However, the hierarchy provided below should be understood to be exemplary of some, but not necessarily all, embodiments of the present invention. As shown in FIG. 4, the highest level in the key hierarchy may be considered to be a device key 62 (or device certificate). The device key 62 may, as indicated above, identify the device and also include or identify a public key and a private key. For non-connected devices, another level in the hierarchy may be included that is not needed or present for connected devices. The additional level in the hierarchy may be a keyset 64. The keyset 64 may be protected with the device key 62. As such, the keyset 64 may only be decrypted by a matching private key. Accordingly, a hacker cannot lie when specifying a UDN—the hacker wouldn't be able to decrypt the keyset 64.

The next level in the hierarchy may be the SEK 66. The SEK 66 may be protected with the device key 62 (e.g., for a connected device) or with the keyset 64 (e.g., for a non-connected device). The SEK 66 may be provided with (or within) a rights object. The rights object may, for example, set a use authority for corresponding content such as playing, displaying, executing, printing, exporting or reading of the content. As such, the rights object may include information about whether or not the use authority for the content exists and the nature of the use authority. As indicated above, the rights object may be delivered either ICRO (e.g., over an interactive channel) or BCRO (e.g., over a broadcast channel). The SEK 66 in the rights object may be used to protect the next lower level of key. A SEK identifier may include a service_CID_extension to provide a content identifier (CID) for the corresponding service. In some embodiments, an optional password encryption key (PEK) 68 may be provided that is protected with the SEK 66. A program_CID_extension may be part of a PEK identifier. However, if the PEK 68 is not utilized, the next level may be a traffic encryption key (TEK) 69 that may be within a STKM (short-term key message) stream. The STKM stream may be a mobile broadcast messaging stream using a single or same SEK 66. Accordingly, if one STKM is employed, there may only be one SEK 66 for the respective service. However, if two STKM streams are employed, there may be two SEKs for the respective service (e.g., one SEK for each respective STKM stream). STKM streams may be carried as different IP streams (e.g., having different IP addresses and port numbers), but included within a single broadcast stream for a particular service. In some instances the STKM stream may be referred to as a key stream message (KSM) in certain standards. The TEK 69 may be protected by the SEK 66 (or PEK 68, if the PEK 68 is employed) and the TEK 69 may encrypt the content. In most instances, the SEK 66 is utilized to decrypt the STKM stream. Thus, if there are two STKM streams, each stream will be decrypted by its respective SEK.

Thus, according to some embodiments of the present invention, since a device characteristic such as the manufacturer's identity may be determined from information at the device key 62 level, groupings may be designated on the basis of manufacturer. The groupings may be formed by the service protector 60 (e.g., via an algorithm or grouping function) or the groupings may be manually input into the service protector 60 by an operator. In either case, when the service protector 60 receives the groupings (e.g., from an internal grouping module or from the operator) the service protector 60 may issue a different SEK to each group. Accordingly, if one group is determined to include devices within the group that have experienced a security leak (e.g., as indicated by a hacker publishing the SEK of the respective group), the grouping may be changed so that, when the next key change occurs and the hacker publishes the hacked key, a determination can be made to at least narrow the candidate manufacturers that may be the source of the security leak. Key and grouping changes may continue to be made until the manufacturer that is the source of the security leak is isolated.

As an example of the grouping and key changes described above, the following scenario is provided. Assume that a broadcaster initially divides the products made by manufacturers A, B, C, D, E, F, G and H such that a first group is defined as including devices manufactured by manufacturers A, B, C and D and a second group is defined as including devices manufactured by manufacturers E, F, G and H. As indicated above, the grouping may be manually done by an operator associated with the broadcaster, or may be automatically done by the service protector 60. Regardless of how the grouping is done, once the groupings are received at the service protector 60, the service protector may issue a different SEK to each respective group as indicated below:

| | | |
|---|---|---|
| Group 1 | Manufacturers A, B, C, D | SEK = 12345678 |
| Group 2 | Manufacturers E, F, G, H | SEK = 87654321. |

If the hacker then publishes key 87654321, it may be determined (either by the operator or, in some embodiments, by the service protector 60) that the compromised security key originated with one of manufacturers E, F, G and H. Either the operator (e.g., using the service protector 60) or the service protector 60 itself may then regroup the devices in a manner that moves at least some of the devices that were in the affected group to the other group and issues a new set of security keys (SEKs) for the next round of rights objects to be delivered to the devices. As an example, devices from manufacturer E and F may be moved to the first group (thereby effectively creating a different first group that may be considered a third grouping). The second group's membership is thereby also changed to effectively define a fourth grouping. Once the regrouping is completed, a new and different SEK may again be issued by the service protector 60 to each respective group as indicated below:

| | | |
|---|---|---|
| Group 1 | Manufacturers A, B, C, D, E, F | SEK = 12123434 |
| Group 2 | Manufacturers G, H | SEK = 56567878. |

Notably, the new SEKs could be issued at a regular SEK change interval (e.g., about one month) or at another time as determined by the operator.

If the hacker publishes key 12123434, the operator or the service protector 60 may then determine that the compromised security key originated with one of manufacturers E and F. Either the operator (e.g., using the service protector 60) or the service protector 60 itself may then regroup the devices again in a manner that moves at least some of the devices that were in the affected group to the other group and issues a new set of security keys (SEKs) for the next round of rights objects to be delivered to the devices. As an example, devices from manufacturer F may be moved to the second group (thereby effectively creating a different second group that may be considered a fifth grouping). The first group's membership is thereby also changed to effectively define a sixth grouping. Once the regrouping is completed, a new and different SEK may again be issued by the service protector 60 to each respective group as indicated below:

| | | |
|---|---|---|
| Group 1 | Manufacturers A, B, C, D, E | SEK = 56781234 |
| Group 2 | Manufacturers F, G, H | SEK = 43218765. |

If the hacker publishes key 43218765, the operator or the service protector 60 may then determine that the compromised security key originated with manufacturer F.

Note that with just two groups, using binary search as described above, it may be possible to divide the number of manufacturers under suspicion by 2 in each step, and thus quickly pinpoint the manufacturer of the devices with compromised keys. In some cases, the devices that are still under suspicion after a previous key change are evenly divided between the two groups based on manufacturer. Other devices can be arbitrarily divided into the groups. Accordingly, unlike the example above, it may be possible to maintain balance in the sizes of the groups, if desired.

As indicated above, an STKM stream is encrypted by a respective SEK, and therefore device groups with different SEKs will typically have different STKM streams. Devices, which prior to embodiments of the present invention only encountered a single STKM stream per service, may need modification in order to handle a situation of encountering multiple STKM streams for a single service. Accordingly, it may be desirable to develop a mechanism for providing devices such as mobile terminals to handle encounters with multiple STKM streams.

In one embodiment, it may be assumed that a particular device encountering more than one STKM stream for a particular service may try to decode both streams with its respective SEK. If the SEK decodes the first STKM stream, the device may then ignore the second STKM stream. However, if the SEK of the device fails to decode the first STKM stream, then the device may attempt to decode the next STKM stream with its respective SEK. In other words, the device may be enabled to check parallel STKM streams, rather than quitting if the first STKM stream encountered is not decryptable using the device's SEK.

In another embodiment, a device encountering more than one STKM stream for a particular service will look at the service_CID_extension carried in one of the STKM streams and compare it with the service_CID_extension carried in the rights object it has for that service. If these two service_CID_extensions are not identical, the device will then try each of the remaining STKM streams until it finds a service_CID_extension that matches the service_CID_extension in the rights object. In most cases, if the number of manufacturer groups (and therefore: number of STKM streams per service) is kept small (e.g., two), browsing through the STKM streams may not be likely to have any noticeable effect on device performance.

In yet another embodiment, rather than utilizing the trial and error approach described above, information may be provided to assist a device in determining which STKM stream to attempt to decode. In this regard, for example, an association between manufacturer and STKM stream (either directly or indirectly) may be communicated to the device. One exemplary way of communicating an association between manufacturer group and STKM stream may be to include information in an attribute in the SDP file. For example, the attribute may include a service_CID_extension to indicate to the device which STKM stream the device can open based on the manufacturer of the device. The matching service_CID_extension is also included in the rights objects provided to devices made by that particular group of manufacturers.

More advantageously, in yet another embodiment, the attribute may include only a part of the service_CID_extension, which said part associates that particular STKM stream with a corresponding rights object provided only to devices made by that particular group of manufacturers, leaving the remaining part of the service_CID_extension to be used as a sequential number that can be changed in each generation of rights objects delivered to terminals to associate the SEK also delivered in the rights object with a particular time period of the STKM stream, without requiring that the SDP file containing the said attribute be updated for each generation of rights objects.

Accordingly, during an exemplary operational scenario, the device may initially enable the review of an ESG. 1n response to selection of a particular program from the ESG, a respective SDP file, which may be part of the service announcement for the selected program, may be consulted to get an IP address. The service announcement may indicate that multiple streams are associated with the service. In this regard, the SDP file may include a list of STKM streams by IP address for each manufacturer group. Thus, a given device may be directed to an STKM stream that the device can decrypt with its respective SEK.

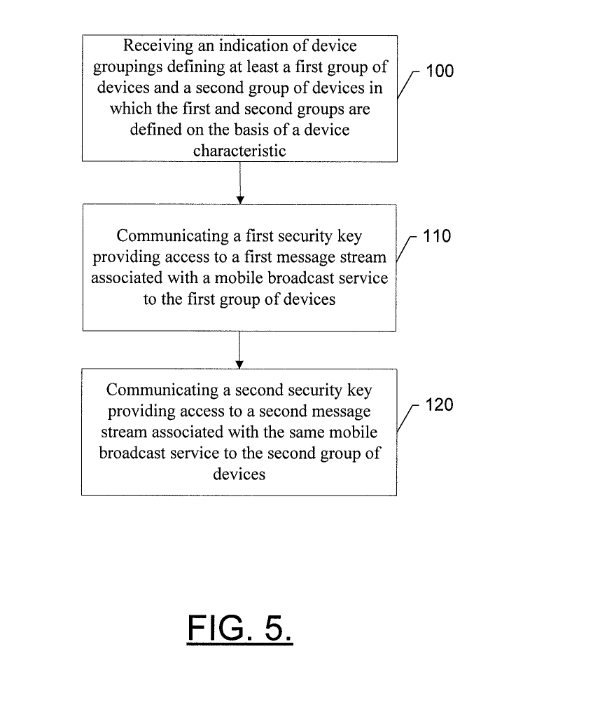

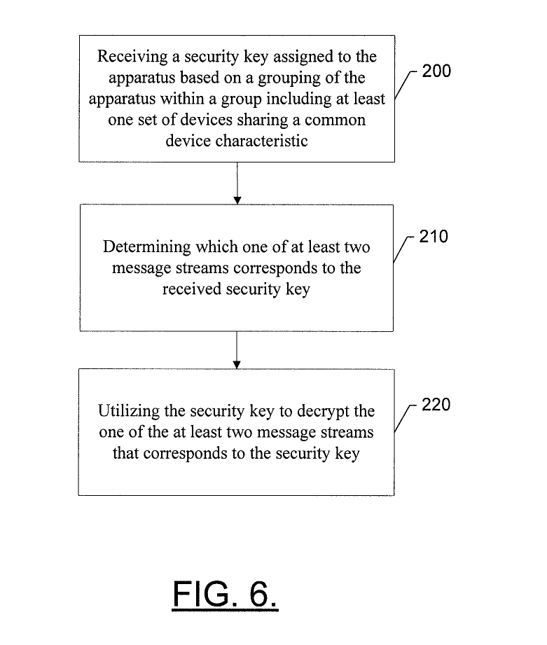

FIGS. 5 and 6 are flowcharts of methods and program products according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or a network device (e.g., the service protector 60) and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing mobile broadcast service protection as illustrated, for example, in FIG. 5 may include receiving an indication of device groupings defining at least a first group of devices and a second group of devices in which the first and second groups are defined on the basis of a device characteristic at operation 100. At operation 110, the method may further include communicating a first security key providing access to a first message stream associated with a mobile broadcast service to the first group of devices. The method may also include communicating a second security key providing access to a second message stream associated with the same mobile broadcast service to the second group of devices at operation 120. The indication of device groupings received in operation 100 may include groupings defined on the basis of a device characteristic indicative of a device manufacturer.

In an exemplary embodiment, the method may further include other operations such as receiving an indication of a regrouping. The regrouping may define a third group of devices including at least one set of devices from a particular manufacturer in the first group and at least one set (which could include one or more devices) of devices from a different manufacturer in the second group and also define a fourth group including sets of devices not included in the third group. The method may further include communicating a third security key to the third group and communicating a fourth security key to the fourth group. In some embodiments, the method may further include determining a compromised one of the first and second security keys prior to defining the third and fourth groups, and defining the third and fourth groups based on splitting sets of devices associated with respective manufacturers in the one of the first and second groups that includes the compromised security key between the third and fourth groups.

In some embodiments, the method of FIG. 5 may further include storing information indicative of the device manufacturer of a plurality of devices in a database for use in grouping devices. In some cases, the method may also include providing information in an electronic service guide to associate the device manufacturer of a particular device with a respective one of the first and second message streams. Although the method may be in continuous operation, in some cases the division of devices into groupings and execution of the method may occur in response to detecting a security leak indicative of a compromised security key originating from a particular device manufacturer.

FIG. 6 is a flowchart according to an exemplary method for providing mobile broadcast service protection from the perspective of a mobile terminal according to an exemplary embodiment of the present invention. As shown in FIG. 6, an exemplary method for providing mobile broadcast service protection may include receiving a security key assigned to the apparatus based on a grouping of the apparatus within a group including at least one set of devices sharing a common device characteristic at operation 200. The method may further include determining which one of at least two message streams corresponds to the received security key at operation 210 and utilizing the security key to decrypt the one of the at least two message streams that corresponds to the security key at operation 220. The device characteristic may be indicative of a manufacturer of the device. In one embodiment, determining which one of the at least two message streams corresponds to the received security key may include attempting to use the security key to decrypt each message stream until the one of the at least two message streams that corresponds to the security key is determined. In an alternative embodiment, determining which one of the at least two message streams corresponds to the received security key may include receiving an indication of which one of the at least two message streams corresponds to the received security key from a portion of an electronic service guide.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of device groupings defining at least a first group of devices and a second group of devices in which the first and second groups are defined on the basis of a device characteristic;
communicating a first security key providing access to a first message stream associated with a mobile broadcast service to the first group of devices; and
communicating a second security key providing access to a second message stream associated with the same mobile broadcast service to the second group of devices in which the first and second security keys are different.

2. A method according to claim 1, wherein receiving an indication of device groupings comprises receiving an indication of groupings defined on the basis of a device characteristic indicative of a device manufacturer.

3. A method according to claim 2, further comprising:
receiving an indication of a regrouping, the regrouping defining a third group of devices including at least one set of devices from a particular manufacturer in the first group and at least one set of devices from a different manufacturer in the second group and defining a fourth group including sets of devices not included in the third group;
communicating a third security key to the third group; and
communicating a fourth security key to the fourth group.

4. A method according to claim 3, further comprising:
determining a compromised one of the first and second security keys prior to defining the third and fourth groups; and
defining the third and fourth groups based on splitting sets of devices associated with respective manufacturers in the one of the first and second groups that includes the compromised security key between the third and fourth groups.

5. A method according to claim 2, further comprising storing information indicative of the device manufacturer of a plurality of devices in a database for use in grouping devices.

6. A method according to claim 2, further comprising providing information in a session description protocol file referred to by an electronic service guide to associate the first or second message stream with a corresponding rights object that is provided to a group of devices made by a particular group of manufacturers.

7. A method according to claim 2, wherein receiving an indication of device groupings occurs in response to detecting a security breach indicative of a compromised security key originating from a particular device manufacturer.

8. A method according to claim 1, wherein the first and second message streams carry encrypted keys, which, when decrypted with the first or second security key, respectively, provide access to the mobile broadcast service.

9. A computer program product comprising at least one computer-readable storage medium having computer-readable program code portions stored therein, the computer-readable program code portions comprising:
a first executable portion for receiving an indication of device groupings defining at least a first group of devices and a second group of devices in which the first and second groups are defined on the basis of a device characteristic;
a second executable portion for communicating a first security key providing access to a first message stream associated with a mobile broadcast service to the first group of devices; and
a third executable portion for communicating a second security key providing access to a second message stream associated with the same mobile broadcast service to the second group of devices in which the first and second security keys are different.

10. A computer program product according to claim 9, wherein the first executable portion includes instructions for receiving an indication of groupings defined on the basis of a device characteristic indicative of a device manufacturer.

11. A computer program product according to claim 10, further comprising:
a fourth executable portion for receiving an indication of a regrouping, the regrouping defining a third group of devices including at least one set of devices from a particular manufacturer in the first group and at least one set of devices from a different manufacturer in the second group and defining a fourth group including sets of devices not included in the third group;
a fifth executable portion for communicating a third security key to the third group; and
a sixth executable portion for communicating a fourth security key to the fourth group.

12. A computer program product according to claim 11, further comprising:
a seventh executable portion for determining a compromised one of the first and second security keys prior to defining the third and fourth groups; and
an eighth executable portion for defining the third and fourth groups based on splitting sets of devices associated with respective manufacturers in the one of the first and second groups that includes the compromised security key between the third and fourth groups.

13. A computer program product according to claim 10, further comprising a fourth executable portion for storing information indicative of the device manufacturer of a plurality of devices in a database for use in grouping devices.

14. A computer program product according to claim 10, further comprising a fourth executable portion for providing information in a session description protocol file referred to by an electronic service guide to associate the first or second message stream with a corresponding rights object that is provided to a group of devices made by a particular group of manufacturers.

15. A computer program product according to claim 10, wherein the first executable portion is executed in response to detecting a security breach indicative of a compromised security key originating from a particular device manufacturer.

16. A computer program product according to claim 9, wherein the first executable portion includes instructions for receiving the first and second message streams carrying encrypted keys, which, when decrypted with the first or second security key, respectively, provide access to the mobile broadcast service.

17. An apparatus comprising a processor configured to:
receive an indication of device groupings defining at least a first group of devices and a second group of devices in which the first and second groups are defined on the basis of a device characteristic;
communicate a first security key providing access to a first message stream associated with a mobile broadcast service to the first group of devices; and
communicate a second security key providing access to a second message stream associated with the same mobile broadcast service to the second group of devices in which the first and second security keys are different.

18. An apparatus according to claim 17, wherein the processor is configured to receiving an indication of device groupings by receiving an indication of groupings defined on the basis of a device characteristic indicative of a device manufacturer.

19. An apparatus according to claim 18, wherein the processor is further configured to:
receive an indication of a regrouping, the regrouping defining a third group of devices including at least one set of devices from a particular manufacturer in the first group and at least one set of devices from a different manufacturer in the second group and defining a fourth group including sets of devices not included in the third group;
communicate a third security key to the third group; and
communicate a fourth security key to the fourth group.

20. An apparatus according to claim 19, wherein the processor is further configured to:
determine a compromised one of the first and second security keys prior to defining the third and fourth groups; and
define the third and fourth groups based on splitting sets of devices associated with respective manufacturers in the one of the first and second groups that includes the compromised security key between the third and fourth groups.

21. An apparatus according to claim 18, wherein the processor is further configured to store information indicative of the device manufacturer of a plurality of devices in a database for use in grouping devices.

22. An apparatus according to claim 18, wherein the processor is further configured to provide information in a session description protocol file referred to by an electronic service guide to associate the first or second message stream with a corresponding rights object that is provided to a group of devices made by a particular group of manufacturers.

23. An apparatus according to claim 18, wherein the processor is further configured to receive an indication of device groupings in response to detection of a security breach indicative of a compromised security key originating from a particular device manufacturer.

24. An apparatus according to claim 17, wherein the processor is further configured to receive the first and second message streams carrying encrypted keys, which, when decrypted with the first or second security key, respectively, provide access to the mobile broadcast service.

25. An apparatus comprising a processor configured to:
receive a security key assigned to the apparatus based on a grouping of the apparatus within a group including at least one set of devices sharing a common device characteristic;
determine which one of at least two message streams corresponds to the received security key; and
utilize the security key to decrypt the one of the at least two message streams that corresponds to the security key.

26. An apparatus according to claim 25, wherein the device characteristic is indicative of a manufacturer of the device, and wherein determining which one of the at least two message streams corresponds to the received security key comprises attempting to use the security key to decrypt each message stream until the one of the at least two message streams that corresponds to the security key is determined.

27. An apparatus according to claim 25, wherein the device characteristic is indicative of a manufacturer of the device, and wherein determining which one of the at least two message streams corresponds to the received security key comprises receiving an indication of which one of the at least two message streams corresponds to the received security key from a portion of an electronic service guide.

28. A computer program product comprising at least one computer-readable storage medium having computer-readable program code portions stored therein, the computer-readable program code portions comprising:
a first executable portion for receiving a security key assigned to the apparatus based on a grouping of the apparatus within a group including at least one set of devices sharing a common device characteristic;
a second executable portion for determining which one of at least two message streams corresponds to the received security key; and
a third executable portion for utilizing the security key to decrypt the one of the at least two message streams that corresponds to the security key.

29. A computer program product according to claim 28, wherein the device characteristic is indicative of a manufacturer of the device, and wherein the second executable portion includes instructions for attempting to use the security key to decrypt each message stream until the one of the at least two message streams that corresponds to the security key is determined.

30. A computer program product according to claim 28, wherein the device characteristic is indicative of a manufacturer of the device, and wherein the second executable portion includes instructions for receiving an indication of which one of the at least two message streams corresponds to the received security key from a portion of an electronic service guide.

31. A method comprising:
receiving a security key assigned to the apparatus based on a grouping of the apparatus within a group including at least one set of devices sharing a common device characteristic;
determining which one of at least two message streams corresponds to the received security key; and
utilizing the security key to decrypt the one of the at least two message streams that corresponds to the security key.

32. A method according to claim 31, wherein the device characteristic is indicative of a manufacturer of the device, and wherein determining which one of the at least two message streams corresponds to the received security key comprises attempting to use the security key to decrypt each message stream until the one of the at least two message streams that corresponds to the security key is determined.

33. A method according to claim 31, wherein the device characteristic is indicative of a manufacturer of the device, and wherein determining which one of the at least two message streams corresponds to the received security key comprises receiving an indication of which one of the at least two message streams corresponds to the received security key from a portion of an electronic service guide.
